(19) United States
(12) Patent Application Publication
(10) Pub. No.: US 2012/0030972 A1
(43) Pub. Date: Feb. 9, 2012

(54) Foldable shoe having a multiple durometer sole

(76) Inventors: Wendy Arnone, (US); Marshall Morrison, (US)

(21) Appl. No.: 13/136,688

(22) Filed: Aug. 8, 2011

Related U.S. Application Data
(60) Provisional application No. 61/401,219, filed on Aug. 9, 2010.

(51) Int. Cl. A43B 13/12; B29D 35/02; C08L 75/04

(52) U.S. Cl. 36/30 R; 525/453; 264/255

(57) ABSTRACT

A multi-durometer foldable shoe sole and method of creating multiple durometer compositions, including shoe soles. In a preferred embodiment, a shoe sole is created with two different durometer polyurethane compositions, one of which has hardness of 10 Shore A durometers and one of which has a hardness of 90 Shore A durometers. The shoe sole itself is created without adhesives, water or compression and held together by the chemical bonds of the composition alone.

### RELATED PATENT APPLICATIONS

This application is a non-provisional patent application of provisional patent application, filed Aug. 8, 2010, and having Ser. No. 61/401,219. Benefit of the Aug. 8, 2010 date is hereby claimed.

### BACKGROUND OF TILE INVENTION

It is a well-known fact to women that high-heel shoes cause sore feet. It has become common for women to carry an extra pair of shoes with flat soles that can be used when walking outside. It is also a common problem that soles of flat-bottomed shoes, such as tennis shoes or ballet flats, separate and fall apart over time. The present invention seeks to remedy both problems by providing a shoe sole that is foldable and will not come apart over time.

It is known to provide a method of molding multi-durometer soles. U.S. Pat. No. 5,362,435 to Volpe discloses a process of molding multi-durometer footwear soles which includes forming elongated components from compression moldable compounds, each component having a different hardness (Shore A). The components are configured and dimensioned such that the softer component will be positioned on top of and within the configuration of the bottom, harder component. The assembled components are placed in a compression molding and covulcanized together. The method for creating the present invention for a multi-durometer sole has eliminated the need for compression molding.

U.S. Pat. No. 6,099,955 to Sakai et al. discloses a urethane foam for shoe soles prepared by reacting a compound having at least two isocyanate-reactive hydrogen atoms and a molecular weight of 400 to 10000 with a polyisocyanate in the presence of a foam stabilizer, water and a catalyst, characterized in that the ratio r.sub.1/r.sub.2 of a mean skill cell diameter r.sub.1 to a mean core cell diameter r.sub.2 is 0.02 to 0.80, wherein the mean skin cell diameter r.sub.1 is defined as the mean diameter of the cells which form the skin portion of a urethane foam extending from the surface to a depth of 5% of the foam thickness and the mean core cell diameter r.sub.2 is defined as the mean diameter of the cells which form the core portion of a urethane foam extending from a depth of 40% to a depth of 60% of the foam thickness. The method for creating the present invention for a sole does not use a foam substance nor does it use water.

### SUMMARY OF THE INVENTION

A foldable shoe and method of creating a shoe sole having a multiple durometer sole is provided. The shoe sole has a top side and a bottom side wherein the top side is in contact with the foot (or a sock) of the wearer and in which an insole material may be affixed and the bottom side has a gap that allows folding of the shoe for transport and/or storage. The shoe has a multiple durometer sole having a hard bottom side and a soft top side. The sole of the shoe is constructed of a multi-part mixture including a composition containing polyisocyanate and polyol constituents, one or more catalyst(s) and/or surfactant(s) or plasticizer(s). The soft portion of the sole is allowed to incompletely cure before the hard portion mixture is added. As a result there is cross-link bonding between the hard and soft mixture and no adhesive is required. The upper portion of the shoe is affixed to the sole using any suitable technique and may be composed of any material deemed suitable by the shoe designer. The upper portion of the shoe may be of the variety of footwear considered as open (eg, sandal) or closed (eg, dress, causal, or athletic shoe; boot). The process by which the sole is constructed may be used to construct any multi-durometer structure.

The object of the present invention is to provide a foldable sole of a shoe wherein the sole has a single layer having at least a first hard surface and a second surface which is soft and in contact with the user. More specifically, the single sole layer may have a hard surface measuring, for example, approximately an 80 Shore A durometer and soft surface measuring approximately a 10 Shore A durometer. However, the process may be altered to obtain any hardness desired by the maker of the sole. The hard and soft surfaces are cross-linked bonded together during the two-step curing process of the present method. The method for creating the present invention for a sole does not use a foam substance nor does it use water.

The method of making a shoe sole having a multiple durometer comprises the steps of: (a) creating a mold of the shoe sole by typical means; (b) pouring the soft durometer mixture of a composition containing polyisocyanate, polyol constituents and phthalate constituent; (c) allowing the mixture to partly cure; (d) adding a second mixture having a composition containing polyisocyanate, polyol constituents and phthalate constituents such that the mixture resides on top of the partly cured first mixture of step “b”; (e) allowing the final mixture to cure until a stable solid.

The method of creating a multi-layer multi-durometer product is not limited to shoe soles alone. The method includes the steps of pouring a mixture of a composition containing polyisocyanate, polyol constituents and phthalate constituent into a mold, allowing it to partially cure before pouring a second mixture of a composition containing polyisocyanate, polyol constituents and phthalate constituents on the first mixture, allowing the mixtures to create a bond between the soft and hard mixtures which does not require adhesives. Rather the end product is crosslink-bonded together such that they will not come apart. This method can also allow for as many multiple layers of adhesive-free bonding as needed depending on the end product sought. Binding layers without adhesive will ensure a bond that will last longer and be more secure than what is in the state of the art presently.

### BRIEF DESCRIPTION OF THE DRAWINGS

FIG. 1 illustrates a flow diagram illustrating consecutive steps of a method embodying this invention for making a multiple-durometer shoe sole;

FIG. 2 illustrates a view of the bottom or underside of a shoe sole having a gap that allows the shoe sole to be folded;

FIG. 3 illustrates a side view of the shoe sole having a gap that allows the shoe sole to be folded;

FIG. 4 illustrates a side view of the shoe sole with an optional mesh-like material between the multi-durometer layers;

FIG. 5 illustrates a blown up view of a FIG. 4's shoe sole with embedded mesh-like material.

### DETAILED DESCRIPTION OF THE PREFERRED EMBODIMENTS

A foldable shoe and method of creating a shoe having a multiple durometer sole, and the process by which, is provided. The shoe sole has a top side and a bottom side wherein the top side is toward the foot (or a sock) of the wearer and bottom side has a gap which allows folding of the shoe for transport and/or storage. More specifically, the bottom side may be comprised of two completely separate hard sole sections. The shoe has a multiple-durometer sole having a hard bottom side, a flexible middle on the bottom side, and a soft top side. The sole of the shoe is constructed of a multi-part mixture including a composition containing at least one polyisocyanate and at least one polyol; one or more catalyst(s) and/or surfactant(s) may also be present. The soft portion of the sole is allowed to incompletely cure before the hard portion mixture is added. As a result, there is cross-link bonding between the hard- and soft-mixture layers and no adhesive is required to affix the adjoining layer to each other.

Cross-links are bonds that link one polymer chain to another. They can be covalent bonds (sharing of electrons) or ionic bonds (electrostatic attraction between a metal and non-metal). In the critical step (e) of the method, the soft mixture and the hard mixture form a strong covalent bond.

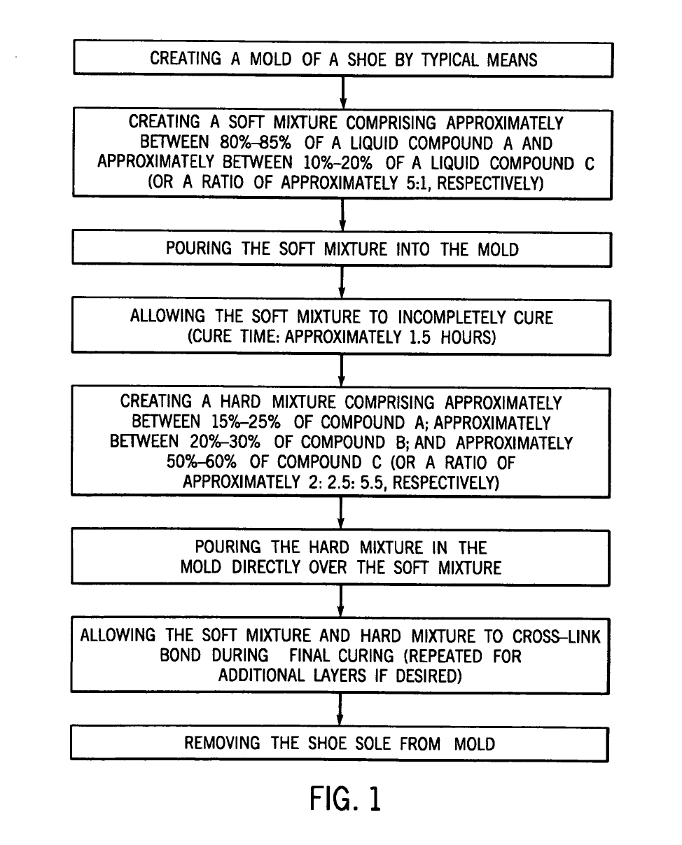

Referring now to FIG. 1, consecutive steps of a method of creating a shoe sole having a multiple durometer sole is provided. The method comprises the steps of: (a) creating a mold of the shoe sole by typical means (creating a blue print of the shoe sole, creating CAD drawings based on the blueprint, creating an aluminum mold based on the CAD drawing); (b) creating a soft durometer mixture of a composition containing polyisocyanate, polyol constituents and phthalate constituents; (c) pouring the soft durometer mixture into the mold and allowing the mixture to partly cure; (d) creating a second harder-durometer mixture of a composition containing polyisocyanate, polyol constituents and phthalate constituents; (e) pouring the second durometer mixture on top of the partly cured first mixture (repeat for additional layers as desired); (f) allowing the final mixture to cure until a stable solid.

With respect to step (b) “creating a soft durometer mixture . . . ”, a user may mix (the soft mixture) approximately between 25-35% of a liquid COMPOUND A, 25-35% of a liquid COMPOUND B and 40-45% of a liquid COMPOUND C by weight. In an embodiment, the soft durometer composition will have a hardness of 1 Shore A durometer. To create the 1 Shore A durometer composition, the optimal percentages by weight are 30.01% of COMPOUND A, 27.07% of COMPOUND B and 42.86% of COMPOUND C. In the preferred embodiment, COMPOUND A is a polyisocyanate. In the preferred embodiment, COMPOUND B is a polygylcol. More specifically, COMPOUND B is an aromatic polygylcol. In the preferred embodiment, COMPOUND C is a phthalate. More specifically, COMPOUND C is a phthalate ester. The desired ratio of COMPOUND A, COMPOUND B AND COMPOUND C is approximately 10:9:14.

With respect to step (b) “creating a soft durometer mixture . . . ”, a user may mix (the soft mixture) approximately between 80%-85% of a liquid COMPOUND A and approximately between 10%-20% of a liquid COMPOUND C by weight. In the preferred embodiment, the soft layer will have a hardness of 10 Shore A durometers. To create the 10 Shore A durometer mixture the optimal percentages may be 83.33% COMPOUND A and 16.67% COMPOUND C. In the preferred embodiment, COMPOUND A is a composition containing polyisocyanate. More specifically, in an embodiment, COMPOUND A may be, for example, methylene diphenyl isocyanate having a functional group of atoms (—N═C═O). In the preferred embodiment, COMPOUND C is a phthalate constituent. More specifically, in the embodiment, COMPOUND C is a phthalate ester. The desired ratio of COMPOUND A to COMPOUND C is approximately 5:1.

With respect to step (b) “creating a soft durometer mixture . . . ”, another embodiment that creates a slightly-harder soft durometer mixture of 15 Shore A durometers, a user would modify the mixture to contain approximately 75-80% of a COMPOUND A, approximately 2% of a COMPOUND B and approximately 15-20% of COMPOUND C by weight. As above, in the preferred embodiment, COMPOUND A is a polyisocyanate and COMPOUND C is a phthalate. In the preferred embodiment, COMPOUND B is a composition containing polyol constituents. The desired ratio of COMPOUND A, COMPOUND B and COMPOUND C is approximately 39:1:10.

With respect to step (c), the new mixture of COMPOUND A and COMPOUND C (from step ‘b” above) is poured into the mold of step (a) and allowed to cure to tackiness, time may vary. In one embodiment, the time for curing to tackiness is approximately 1.5 hours. The amount of time used in step (c) for the curing allows the mixture of A and C to cure partially but not fully such that the addition of the hard mixture created in step (d) will adhere to and bond with the softer mixture of step (b). It should be noted that this amount of time may change depending on the desired procedure and the desired hardness of each mixture.

With respect to step (d), a user may mix (the hard mixture) approximately to between 15%-25% of a liquid COMPOUND A; approximately between 20%-30% of a liquid COMPOUND B and approximately 50%-60% of liquid COMPOUND C. In a preferred embodiment, with a hardness of 90 Shore A durometer, the optimal percentages may be approximately 20% COMPOUND A, 25% COMPOUND B and 54% COMPOUND C. More specifically, the desired ratio of COMPOUND A to COMPOUND B to COMPOUND C is approximately 2:2.5:5.5, respectively. The “hard mixture” of this step is added to the soft mixture of step (b) after approximately 1.5 hours. The harder mixture in this step requires a tighter cross-link chemistry, and therefore smaller molecules are desired. As a result, the soft mixture casting does not fully cure and the soft mixture and hard mixture may cross-link and bond together without the use of adhesives. As a hardness of a polyurethane compound increases more isocyanate is required in the mixture to obtain the stoichiometric between the hardness and the curative components. As with step (b), the ratio of COMPOUNDS may be altered to vary the hardness or softness of the “hard” layer to the user's desired consistency.

In practice, the user simply pours the hard mixture (comprising COMPOUND A, COMPOUND B and COMPOUND C) directly on top of the soft mixture of step (b). The hard mixture of step (d) then covers the top surface of the soft mixture of step (b) and forms a perimeter identical to that of the mold. As a result, the soft mixture and hard mixture combine to form an inseparable single layer material having at least two distinct hardness levels. In an embodiment, a top plate mold may be used to shape the exposed hard mixture portion by placing the top plate mold over the hard mixture immediately after pouring the same. The top plate mold may have an elongated extension running from one side of the shoe sole 1 to the other side of the shoe sole 1. The elongated extension may form the gap 20 in the hard layer (as described below). Such mold may also be used to create any design on the hard layer that would act for traction when the sole is in use.

With respect to step (f) allowing the final mixture to cure until stable solid. Cure time will vary depending on “hardness” of mixtures used. The process of curing the hard mixture and soft mixture does not require the addition of water or additional heat. The preferred embodiment utilizes ambient standard room temperature.

When cured to stable solid state, the shoe sole 1 may be removed from the mold as a single unit having two or more distinct durometer hardness readings. It should be noted that the present method describes the cross-linking between two “layers” (one soft and one hard). It should be understood that any number of “layers” may be used to provide a shoe sole having multiple-durometer readings. More specifically, the process may be repeated by adding new compound(s) while the previous mixtures are still in the curing process. It should also be noted that the mixtures may be added in any order (soft then hard or hard then soft) depending on the mold used or process needed. The multiple layers of polymer of varying durometers are stacked according to the method used to make the shoe sole. When the layers are stacked as in the new invention herein, when the layers cure to stable solid state, they bond to each other without the use of adhesives. The method by which the sole is constructed may be used to construct any multi-durometer layered entity.

In an embodiment, approximately 500 g of total mixture are needed to produce an average pair of shoes 1. It should be noted that this amount may vary based on, for example, the size of the shoe sole, the type of the shoe sole, the number of layers of varying durometers, the desired thickness 17 (as described below) or the overall shape of the shoe 1.

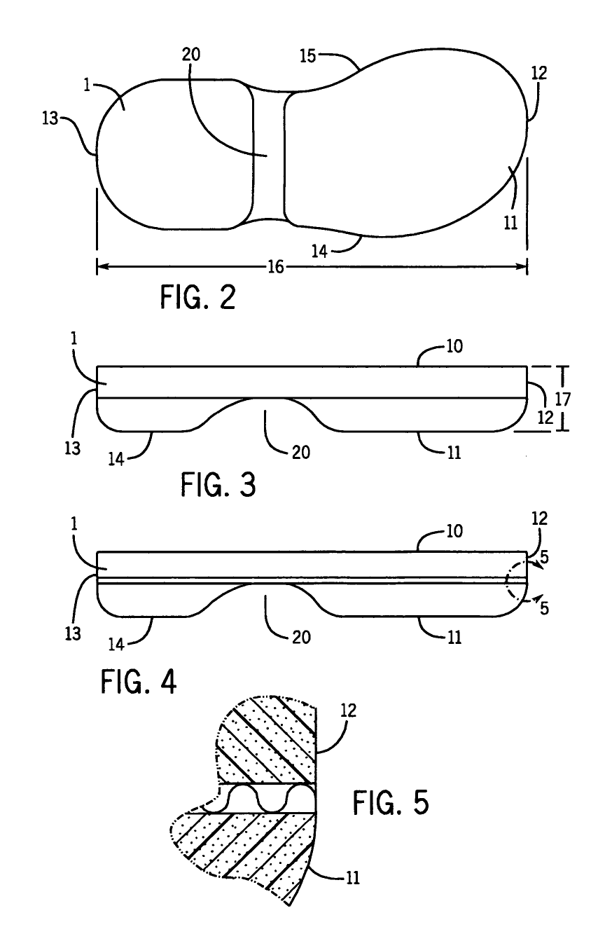

With respect to FIGS. 2 and 3, the shoe sole 1 may be easily folded for transport and/or storage. The shoe sole 1 may have a top side 10, a bottom side 11, a front 12, a back 13, a first side 14, a second side 15, a length 16 and a thickness 17. The thickness 17 may vary along the length 16 of the shoe sole 1. For example, the back 13 (the heal portion) may have a greater thickness 17 than the front 12 (the toe portion) of the shoe sole 1. The altered thickness 17 along the length 16 of the shoe sole 1 may create functional arch support, increase comfort and may be stylish.

A gap 20 or other indentation may run largely perpendicular with respect to the length 16 of the shoe sole 1. More specifically, the gap 20 may extend substantially from the first side 14 of the shoe sole 1 to the second side 15 of the shoe sole 1. As a result of the flexible lower durometer material present along the gap line 20, the shoe 1 may easily be folded such that the top side 10 over the back 13 (the heal portion) may be forced toward the top side 10 over the front 12 of the shoe sole 1. More specifically, the shoe sole 1 may essentially collapse such that the top side 10 is brought together and the bottom side 11 substantially covers the exterior of the folded shoe. When folded, the top side 10 may be protected from wear or damage by the now exterior bottom side 11.

The gap 20 of the shoe sole 12 may extend substantially or totally through the “hard mixture” bottom portion of the shoe sole 1, as described in step (d) above. The gap 20 may constitute a single fold in the sole or the sole may contain up to two gaps 20 to allow the sole to fold multiple times. As a result, the shoe 1 maybe easily folded through the “soft mixture” top portion of step (b) above. In one embodiment, the sole 1 may not contain any gap 20 if the user creates a softer durometer hardness in step (d) such that the layer is soft enough to roll up rather than fold.

In regards to FIGS. 4 and 5, after the completion of step (b) in FIG. 1, a mesh-like material 30 may be placed on top of the “soft mixture” prior to step (e) where the “hard mixture” is poured over the “soft mixture.” In this embodiment, the mesh-like material 30 acts to further support the sole 1 to prevent tearing or damage to the sole during folding. In one embodiment the mesh-like material would be a polyethylene. In another embodiment, the mesh like material would be a polyproplyene. Upon curing, the mesh-like material 30 is embedded between the soft layer 12 and hard layer 11. The mesh-like material 30 may be embedded throughout the entire length 16 of the sole 1 or may be limited only to that gap 20.

Although embodiments of the invention are shown and described therein, it should be understood that various changes and modifications to the presently preferred embodiments will be apparent to those skilled in the art. Such changes and modifications may be made without departing from the spirit and scope of the invention and without diminishing its attendant advantages.

I claim:

1. A shoe sole compromising
a softer hardness durometer top layer of a sole in direct contact with and bonded to a harder durometer layer
a harder hardness durometer bottom layer of a sole in direct contact with and bonded to a softer durometer layer
the two layers are molecularly bonded together during curation in order to form a single sole with multiple durometers.

2. The composition of claim 1 in which a mesh-like material made of polyethylene is embedded between the softer top layer and harder bottom layer.

3. The composition of claim 1 in which the range of hardness is between 1 and 90 Shore A durometers.

4. The composition of claim 1 where the sole has one or more gaps in the hard durometer layer that allow for folding of the sole.

5. The variable hardness polyurethane system compromising
a polyurethane resin
a curing agent or catalyst
a second catalyst or plasticizer
the components for the first layer being miscible and when combined in varying proportions creating compounds of various hardness with a range of hardness from 1 to 90 Shore A durometers
the components for the second layer being miscible and when combined in varying proportions creating compounds of various hardness with a range of hardness from 1 to 90 Shore A durometers
the compounds of the first and second layer are molecularly bonded together when placed in direct contact to one another in a mold.

6. The polyurethane system of claim 5 in which the polyurethane resin is a polyisocyanate.

7. The polyurethane system of claim 5 in which the curing agent or first catalyst is a polyol.

8. The polyurethane system of claim 5 in which the second catalyst or plasticizer is a phthalate.

9. The polyurethane system of claim 5 in which the second catalyst or plasticizer is a phthalate ester.

10. The polyurethane system of claim 5 in which the curing agent or first catalyst is polygylcol.

11. The polyurethane system of claim 5 in which the curing agent or first catalyst is a toluene diamine.

12. The polyurethane system of claim 5 in which the second catalysts or plasticizer is a surfactant.

13. The polyurethane system of claim 5 in which the component layers have a hardness between 1 and 90 Shore A durometers.

14. A method of creating polyurethane components with varying hardnesses that molecularly bond with each other compromising the steps of:
a. Creating the first layer of variable hardness polyurethane composition as described in claim 5
b. Creating the second layer of variable hardness polyurethane composition as described in claim 5
c. Pouring the compositions into a mold one a time and allowing partial curation between additions.
d. The layering of components can be done multiple times to allow multiple layers of variable hardness component layers.
e. Allowing the composition to solidify prior to removal from the mold.

15. The method of claim 14 in which more than two layers are created and bonded together using the same method.
